(19) United States
(12) Patent Application Publication
(10) Pub. No.: US 2024/0103281 A1
(43) Pub. Date: Mar. 28, 2024

(54) INFORMATION PROCESSING METHOD, RECORDING MEDIUM, AND INFORMATION PROCESSING SYSTEM

(71) Applicant: Panasonic Intellectual Property Corporation of America, Torrance, CA (US)

(72) Inventors: Kotaro SAKATA, Osaka (JP); Tetsuji FUCHIKAMI, Osaka (JP)

(21) Appl. No.: 18/535,148

(22) Filed: Dec. 11, 2023

Related U.S. Application Data
(63) Continuation of application No. PCT/JP22/14859, filed on Mar. 28, 2022.

(30) Foreign Application Priority Data
Jun. 18, 2021 (JP) 2021-101522

(51) Int. Cl. G02B 27/01; G06V 40/20

(52) U.S. Cl. CPC G02B 27/0172; G06V 40/20

(57) ABSTRACT

An information processing method that is executed by a computer includes: obtaining a video obtained by capturing a head-mounted display (HMD) user wearing an HMD or information about visual content presented on the HMD; determining whether the HMD user will take an action that affects a nearby user who is present within a predetermined range corresponding to the HMD user, based on the video or the information about the visual content; and presenting alert information to at least one of the HMD user or the nearby user when the HMD user is determined to take an action that affects the nearby user.

### CROSS REFERENCE TO RELATED APPLICATIONS

This is a continuation application of PCT International Application No. PCT/JP2022/014859 filed on Mar. 28, 2022, designating the United States of America, which is based on and claims priority of Japanese Patent Application No. 2021-101522 filed on Jun. 18, 2021. The entire disclosures of the above-identified applications, including the specifications, drawings and claims are incorporated herein by reference in their entirety.

### FIELD

The present disclosure relates to an information processing method, a recording medium, and an information processing system.

### BACKGROUND

A technique for presenting visual content on the head-mounted display (hereinafter referred to as HMD) worn by a user has been disclosed (for example, Patent Literature (PTL) 1 and PTL 2). This allows a user wearing an HMD (hereinafter referred to as an HMD user) to conduct or listen to a presentation or a lecture in a virtual space such as a meeting room or a classroom shown in visual content, while the user is in a real space (for example, an office). Alternatively, safety training (dangerous experience) can be conducted in a virtual space such as a work site shown in visual content.

### CITATION LIST

### Patent Literature

PTL 1: Japanese Patent No. 6770178
PTL 2: WO2020/070839

### SUMMARY

### Technical Problem

However, HMDs often block the views of HMD users, and HMD users often do not know their situations in the real world. For example, when an HMD user gives a presentation in a virtual space, the HMD user may move his/her arm also in the real world. When the HMD user performs work in a virtual space, the HMD user may move to a different position also in the real world. At this time, the HMD user cannot recognize the presence of a nearby user in the real world, and may collide or come into contact with the nearby user.

In view of this, the present disclosure provides an information processing method that can inhibit collision or contact between an HMD user and a user around the HMD user.

### Solution to Problem

An information processing method according to the present disclosure is an information processing method that is executed by a computer. The information processing method includes: obtaining a video obtained by capturing a head-mounted display (HMD) user wearing a head-mounted display or information about visual content presented on the head-mounted display; determining whether the HMD user will take an action that affects a nearby user who is present within a predetermined range corresponding to the HMD user, based on the video or the information about the visual content; and presenting alert information to at least one of the HMD user or the nearby user when the HMD user is determined to take an action that affects the nearby user.

Note that these general or specific aspects of the present disclosure may be achieved as a system, a method, an integrated circuit, a computer program, or a computer-readable recording medium such as a CD-ROM, or may be achieved as any combination of systems, methods, integrated circuits, computer programs, and recording media.

### Advantageous Effects

An information processing method and so on according to an aspect of the present disclosure can inhibit collision or contact between an HMD user and a user around the HMD user.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating an example of an information processing system according to an embodiment.

FIG. 2 is a diagram illustrating an application example of an information processing method or the information processing system according to the embodiment.

FIG. 3 is a flowchart illustrating an example of operations of the information processing system according to the embodiment.

FIG. 4A is a diagram illustrating an example of a predetermined range.

FIG. 4B is a diagram illustrating an example of the predetermined range.

### Description of Embodiment

An information processing method according to an aspect of the present disclosure is an information processing method that is executed by a computer. The information processing method includes: obtaining a video obtained by capturing a head-mounted display (HMD) user wearing an HMD or information about visual content presented on the HMD; determining whether the HMD user will take an action that affects a nearby user who is present within a predetermined range corresponding to the HMD user, based on the video or the information about the visual content; and presenting alert information to at least one of the HMD user or the nearby user when the HMD user is determined to take an action that affects the nearby user.

With this, alert information is presented to the HMD user or the nearby user when the HMD user is determined to take an action that affects the nearby user based on the video obtained by capturing the HMD user or the information about the visual content presented on the HMD. Therefore, collision or contact between the HMD user and the user around the HMD user can be inhibited. For example, the HMD user and the nearby user can both be present at the same time in the same area.

For example, in the determining, a situation of the HMD user in the visual content may be analyzed using the information about the visual content, and whether the HMD user will take an action that affects the nearby user may be determined based on the situation analyzed.

With this, what kind of situation the HMD user is in can be analyzed based on the details of the visual content. Therefore, whether the HMD user will take an action that affects the nearby user can be determined based on the analyzed situation. For example, when the HMD user is analyzed to be in a situation in which the HMD user moves his/her arm or move to a different position, the HMD user can be determined to take an action that affects the nearby user.

For example, in the determining, a movement of the HMD user may be analyzed based on the video, and whether the HMD user will take an action that affects the nearby user may be determined based on the movement determined.

With this, what kind of movement the HMD user is doing can be analyzed based on the video showing the HMD user. Therefore, whether the HMD user will take an action that affects the nearby user is determined based on the movement determined. For example, when the HMD user is analyzed to move his/her arm or move to a different position, the HMD user can be determined to take an action that affects the nearby user.

For example, the information processing method may further include determining whether the nearby user is likely to approach the HMD user. In the presenting, when the HMD user is determined to take an action that affects the nearby user and the nearby user is determined to be likely to approach the HMD user, the alert information may be presented to at least one of the HMD user or the nearby user.

With this, since the possibility that the HMD user and the nearby user collide or come into contact with each other increases when the nearby user is likely to approach the HMD user, alert information is presented in such a case and collision or contact between the HMD user and the nearby user can be inhibited.

For example, the predetermined range may be a range of a predetermined distance from the HMD user. Alternatively, for example, the predetermined range may be an area in which the HMD user is present.

For example, in the presenting, the alert information may be presented using tactile feedback.

With this, it is possible to provide an alert using tactile feedback.

A recording medium according to an aspect of the present disclosure is a non-transitory computer-readable recording medium having recorded thereon a program for causing a computer to execute the information processing method described above.

With this, a program that can inhibit collision or contact between an HMD user and a user around the HMD user can be provided.

An information processing system according to an aspect of the present disclosure includes: an obtainer that obtains a video obtained by capturing a head-mounted display (HMD) user wearing an HMD or information about visual content presented on the HMD; an HMD user situation determiner that determines whether the HMD user will take an action that affects a nearby user who is present within a predetermined range corresponding to the HMD user, based on the video or the information about the visual content; and a presenter that presents alert information to at least one of the HMD user or the nearby user when the HMD user is determined to take an action that affects the nearby user.

With this, an information processing system that can inhibit collision or contact between an HMD user and a user around the HMD user can be provided.

The following specifically describes an embodiment with reference to the drawings.

Note that each of the embodiments described below shows a general or specific example. The numerical values, shapes, materials, structural elements, the arrangement and connection of the structural elements, steps and the order of the steps mentioned in the following embodiments are mere examples and not intended to limit the present disclosure.

### Embodiment

The following describes an information processing system and an information processing method according to an embodiment.

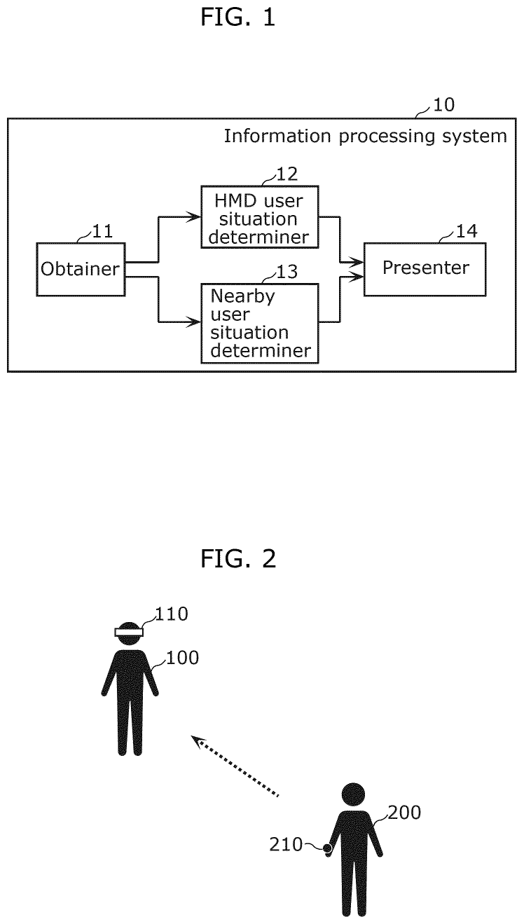

FIG. 1 is a diagram illustrating an example of information processing system 10 according to an embodiment.

Information processing system 10 is a system that can communicate with, for example, wearable devices worn by a plurality of users in a space such as an office in which the users are present. The users wear, for example, HMDs or smartwatches as wearable devices. Information processing system 10 is an example of a computer that executes an information processing method. For example, information processing system 10 is a device such as a server. Note that information processing system 10 may be an HMD. Moreover, structural elements included in information processing system 10 may be distributed over a plurality of devices. In this case, the information processing method may be performed by a plurality of computers. For example, the structural elements included in information processing system 10 may be distributed over a server and an HMD.

Information processing system 10 includes obtainer 11, HMD user situation determiner 12, nearby user situation determiner 13, and presenter 14. Information processing system 10 is a computer including a processor, a communication interface, and memory, for example. Memory includes a read only memory (ROM) and random access memory (RAM), for example, and can store a program that is executed by the processor. Obtainer 11, HMD user situation determiner 12, nearby user situation determiner 13, and presenter 14 may be achieved by, for example, a processor that executes the program stored in the memory. For example, obtainer 11 and presenter 14 transmit and receive information to and from, for example, HMDs and smartwatches, via the communication interface.

Obtainer 11 obtains information about visual content presented on an HMD. For example, information processing system may have a function of causing an HMD to present visual content and may store the visual content in the memory, and obtain, from the memory, information about the visual content presented on the HMD. Another option is that obtainer 11 may obtain, from an HMD, information about the visual content presented on the HMD.

Alternatively, obtainer 11 obtains a video obtained by capturing an HMD user. For example, an HMD may be provided with a camera to capture outside (for example, below) the HMD. Obtainer 11 may obtain, from the camera, a video obtained by capturing, for example, arms of the HMD user. Another option is that obtainer 11 may obtain a video obtained by capturing an HMD user from a camera provided on a ceiling or a wall in a space in which the HMD user is present. Obtainer 11 may also obtain a video obtained by capturing a nearby user (the details will be described later) from the camera.

Note that obtainer 11 may obtain both of the information about visual content presented on an HMD and the video obtained by capturing an HMD user, or one of the information about visual content presented on an HMD or the video obtained by capturing an HMD user.

Obtainer 11 may also obtain information indicating positional relationships between users in a space in which the users are present. For example, the information indicating positional relationships between users may be obtained from a sensor provided on a ceiling or wall in the space in which the users are present. The sensor may be a laser scanner using Time of Flight (ToF), and can detect positional relationships between the users.

Moreover, obtainer 11 may obtain entry and exit records of one or more users who enter or exit an area in which an HMD user is present.

Note that, for example, the following functions of obtainer 11 may be distributed over a plurality of devices: a function of obtaining information about visual content presented on an HMD, a function of obtaining a video obtained by capturing an HMD user, a function of obtaining a video obtained by capturing a nearby user, a function of obtaining information indicating positional relationships between users, and a function of obtaining entry and exit records of one or more users.

HMD user situation determiner 12 determines whether an HMD user will take an action that affects a nearby user who is present within a predetermined range corresponding to the HMD user, based on a video obtained by capturing the HMD user or information about visual content presented on the HMD. The details of operations of HMD user situation determiner 12 will be described later.

Nearby user situation determiner 13 determines whether the nearby user is likely to approach the HMD user. The details of operations of nearby user situation determiner 13 will be described later.

When the HMD user is determined to take an action that affects the nearby user, presenter 14 presents alert information to at least one of the HMD user or the nearby user. In the present embodiment, when the HMD user is determined to take an action that affects the nearby user and the nearby user is determined to be likely to approach the HMD user, presenter 14 presents alert information to at least one of the HMD user or the nearby user. The details of operations of presenter 14 will be described later.

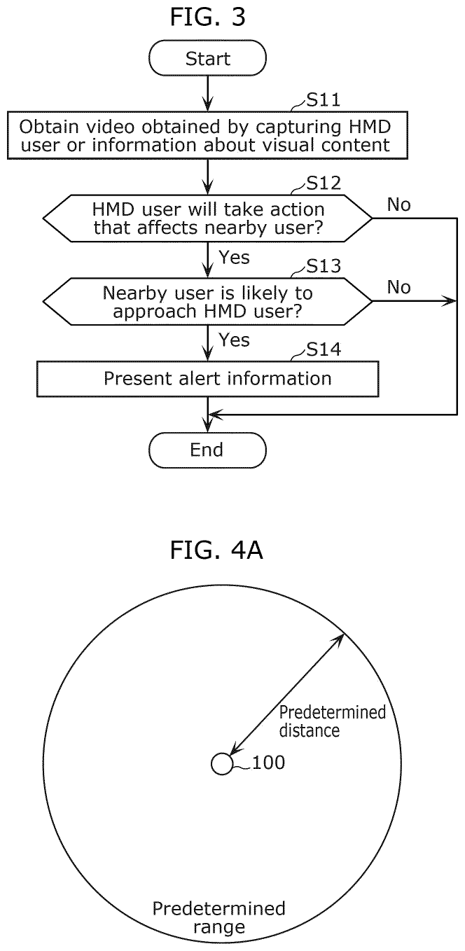

Next, the details of an information processing method and information processing system 10 will be described with reference to FIG. 2 and FIG. 3.

FIG. 2 is a diagram illustrating an application example of the information processing method or information processing system 10 according to the embodiment.

As illustrated in FIG. 2, HMD user 100 wears HMD 110, and nearby user 200 located around HMD user 100 wears smartwatch 210. The view of HMD user 100 is blocked by HMD 110, and therefore HMD user 100 does not know his/her situation in real world. For example, when HMD user 100 gives a presentation in a virtual space, HMD user 100 may move his/her arm and so on also in the real world. When HMD user 100 performs work in a virtual space, HMD user 100 may move to a different position also in the real world. At this time, HMD user 100 cannot recognize the presence of nearby user 200 in the real world, and may collide or come into contact with nearby user 200. The information processing method or information processing system 10 according to the present embodiment can inhibit collision or contact between HMD user 100 and nearby user 200.

FIG. 3 is a flowchart illustrating an example of operations of information processing system 10 according to the embodiment. Note that information processing system 10 is an example of a computer that executes the information processing method according to the embodiment. Therefore, FIG. 3 is also a flowchart illustrating an example of the information processing method according to the embodiment. Obtainer 11 corresponds to obtaining information about visual content presented on HMD 110 and obtaining a video obtained by capturing HMD user 100 in the information processing method. HMD user situation determiner 12 corresponds to determining whether HMD user 100 will take an action that affects nearby user 200. Nearby user situation determiner 13 corresponds to determining whether nearby user 200 is likely to approach HMD user 100. Presenter 14 corresponds to presenting alert information.

First, obtainer 11 obtains a video obtained by capturing HMD user 100 or information about visual content presented on HMD 110 (step S11).

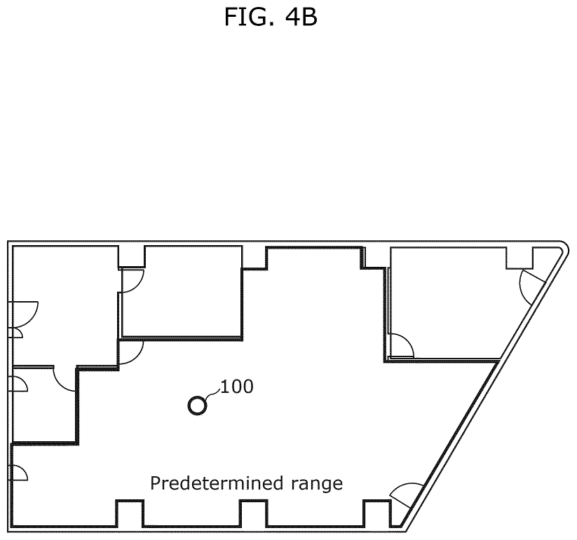

Next, HMD user situation determiner 12 determines whether HMD user 100 wearing HMD 110 will take an action that affects nearby user 200 who is present within a predetermined range corresponding to HMD user 100, based on the video obtained by capturing HMD user 100 or the information about visual content presented on HMD 110 (step S12). Here, the predetermined range corresponding to HMD user 100 will be described with reference to FIG. 4A and FIG. 4B.

Each of FIG. 4A and FIG. 4B is a diagram illustrating an example of the predetermined range.

As illustrated in FIG. 4A, the predetermined range may be a range of a predetermined distance from HMD user 100. The predetermined distance may be any distance. For example, the predetermined distance may be 5 m. For example, HMD user situation determiner 12 may determine whether another user is present in a range of the predetermined distance from HMD user 100 using positional relationships between users obtained by obtainer 11 (especially the positional relationship between HMD user 100 and another user), and determine, as nearby user 200, the other user who is determined to be present in the range of the predetermined distance from HMD user 100.

Note that, for example, a wearable device worn by HMD user 100 or a mobile phone carried by HMD user 100 may be mutually communicate with a wearable device worn by another user or a mobile phone carried by the other user. Obtainer 11 may obtain, from these devices, information indicating signal strength of communication between these devices, for example. HMD user situation determiner 12 may determine whether another user is present in the range of the predetermined distance from HMD user 100 using information indicating, for example, the signal strength of communication obtained by obtainer 11, and determine, as nearby user 200, the other user who is determined to be present in the range of the predetermined distance from HMD user 100.

Alternatively, as illustrated in FIG. 4B, the predetermined range may be an area (for example, a room) in which HMD user 100 is present. Note that the area in which HMD user 100 is present is not limited to a room, and may also be a partitioned area. For example, HMD user situation determiner 12 may determine whether another user is present in the area in which HMD user 100 is present using entry and exit records, obtained by obtainer 11, of one or more users who enter or exit the area in which HMD user 100 is present, and determine, as nearby user 200, the other user who is determined to be present in the area in which HMD user 100 is present.

For example, an action taken by HMD user 100 that affects nearby user 200 is an action in which HMD user 100 may collide or come into contact with nearby user 200. Specifically, for example, such an action is that HMD user 100 moves his/her arm or moves to a different position.

For example, HMD user situation determiner 12 may determine whether HMD user 100 will take an action that affects nearby user 200, based on information about visual content presented on HMD 110. Specifically, HMD user situation determiner 12 may analyze a situation of HMD user 100 in the visual content using the information about the visual content presented on HMD 110, and determine whether HMD user 100 will take an action that affects nearby user 200 based on the situation analyzed. The information about the visual content presented on HMD 110 is, for example, an image viewed by HMD user 100, i.e., an image of the vision of HMD user 100.

For example, when the image viewed by HMD user 100 is an image from a platform in a class room or the like, the situation of HMD user 100 in the visual content can be analyzed to be a situation of giving a presentation. In this case, HMD user 100 is likely to move his/her arm to explain something during the presentation, and HMD user 100 can be determined to take an action that affects nearby user 200. For example, the image viewed by HMD user 100 is an image in which a platform in a class room or the like is in front of HMD user 100, the situation of HMD user 100 in the visual content can be analyzed to be a situation of listening to a presentation. In this case, HMD user 100 is less likely to move his/her arm, and HMD user 100 can be determined not to take an action that affects nearby user 200.

Moreover, HMD user situation determiner 12 may determine whether HMD user 100 will take an action that affects nearby user 200, based on a positional relationship between an object presented in the visual content and HMD user 100 in the visual content. For example, the image viewed by HMD user 100 is an image from a platform in a class room or the like and a screen that is present near the platform in the class room or the like is shown on the left side of the vision of HMD user 100, the situation of HMD user 100 in the visual content can be analyzed to be a situation of giving a presentation on the right side of the platform as viewed from HMD user 100. In this case, HMD user 100 is likely to move his/her left arm to explain something during the presentation using the screen on the left-hand side, and it is possible to determine that HMD user 100 may take an action that affects nearby user 200 (especially nearby user 200 on the left side of HMD user 100).

Alternatively, for example, HMD user situation determiner 12 may determine whether HMD user 100 will take an action that affects nearby user 200, based on a video obtained by capturing HMD user 100. Specifically, HMD user situation determiner 12 may determine a movement of HMD user 100 based on the video obtained by capturing HMD user 100, and determine whether HMD user 100 will take an action that affects nearby user 200, based on the determined movement.

As mentioned above, HMD 110 may include a camera that captures outside (for example, below) HMD 110, obtainer 11 may obtain, from the camera, a video obtained by capturing arms of the HMD user. Alternatively, obtainer 11 may obtain a video obtained by capturing HMD user 100, from a camera provided on a ceiling or a wall of the space in which HMD user 100 is present. In these videos, when HMD user 100 is moving his/her arm or HMD user 100 is moving to a different position, HMD user 100 can be determined to take an action that affects nearby user 200.

Next, when HMD user 100 is determined to take an action that affects nearby user 200 (Yes in step S12), nearby user situation determiner 13 determines whether nearby user 200 is likely to approach HMD user 100 (step S13). For example, nearby user situation determiner 13 may determine whether nearby user 200 is likely to approach HMD user 100, using a video in which nearby user 200 is captured, which is obtained by obtainer 11. For example, when nearby user 200 stands up when nearby user 200 is working while sitting on a chair, nearby user 200 may be determined to be likely to approach HMD user 100. Alternatively, when nearby user 200 faces toward HMD user 100, nearby user 200 may be determined to be likely to approach HMD user 100.

Then, when HMD user 100 is determined to take an action that affects nearby user 200 and nearby user 200 is determined to be likely to approach HMD user 100 (Yes in step S13), presenter 14 presents alert information to at least one of HMD user 100 or nearby user 200 (step S14). Presenter 14 may present alert information to each of HMD user 100 and nearby user 200, or may present alert information to only one of HMD user 100 or nearby user 200.

For example, presenter 14 may present alert information using tactile feedback. For example, presenter 14 may alert nearby user 200 by transmitting alert information to smartwatch 210 worn by nearby user 200 and causing smartwatch 210 to vibrate. Although not illustrated in FIG. 2, HMD user 100 may wear a smartwatch, and presenter 14 may cause the smartwatch to vibrate to alert HMD user 100.

For example, presenter 14 may present alert information using audio or one or more characters. For example, presenter 14 may transmit alert information to HMD 110 worn by HMD user 100 to cause HMD 110 to output audio alerting HMD user 100, or cause HMD 110 to display one or more characters alerting HMD user 100. Moreover, for example, presenter 14 may alert nearby user 200 by transmitting alert information to smartwatch 210 worn by nearby user 200 and causing smartwatch 210 to output audio alerting nearby user 200 or display one or more characters alerting nearby user 200. Although not illustrated in FIG. 2, HMD user 100 may wear a smartwatch, and presenter 14 may cause the smartwatch to output audio alerting HMD user 100 or display one or more characters alerting HMD user 100.

When HMD user 100 is determined not to take an action that affects nearby user 200 (No in step S12), or nearby user 200 is determined not to be likely to approach HMD user 100 (No in step S13), presenter 14 does not present alert information.

Note that although FIG. 3 illustrates an example in which step S13 is performed when the result is Yes in step S12 and step S14 is performed when the result is Yes in step S13, step S12 may be performed when the result is Yes in step S13 and step S14 may be performed when the result is Yes in step S12.

As described above, alert information is presented to HMD user 100 or nearby user 200 when HMD user 100 is determined to take an action that affects nearby user 200. Therefore, collision or contact between HMD user 100 and nearby user 200 can be inhibited. For example, HMD user 100 and nearby user 200 can both be present at the same time in the same area.

### OTHER EMBODIMENTS

The information processing method and information processing system 10 according to one or more aspects of the present disclosure have been described above based on the embodiment described above, but the present disclosure should not be limited to the above embodiment. Such one or more aspects of the present disclosure may include variations achieved by making various modifications to each of the embodiments that can be conceived by those skilled in the art or forms achieved by combining structural elements in different embodiments without departing from the teachings of the present disclosure.

For example, in the embodiment described above, an example has been described in which information processing system 10 include nearby user situation determiner 13, but information processing system 10 does not need to include nearby user situation determiner 13. Stated differently, in the embodiment described above, an example has been described in which the information processing method includes determining whether nearby user 200 is likely to approach HMD user 100, but the information processing method does not need to include this step. In other words, in FIG. 3, the process in step S13 does not need to be performed, and when HMD user 100 is determined to take an action that affects nearby user 200 (Yes in step S12), presenter 14 may present alert information to at least one of HMD user 100 or nearby user 200 (step S14).

For example, in the embodiment described above, HMD 110 or smartwatch 210 has been described as an example of a device on which alert information is presented, but the present disclosure is not limited to this example. For example, alert information may be presented on a mobile terminal carried by HMD user 100 or nearby user 200, or presented on a display or through a loudspeaker provided in a space in which HMD user 100 or nearby user 200 is present.

Note that the present disclosure is not limited to an HMD, and also applicable to other head-mounted devices such as smart glasses, augmented reality (AR) glasses, or mixed reality (MR) glasses. In other words, in the present disclosure, the HMD can be replaced with other head-mounted devices such as smart glasses, AR glasses, or MR glasses, and the HMD user can be replaced with a user wearing other head-mounted devices such as smart glasses, AR glasses, or MR glasses.

For example, the present disclosure can be achieved as a program for causing a processor to execute the steps included in the information processing method. Moreover, the present disclosure can be achieved as a non-transitory computer-readable recording medium, such as a CD-ROM, having the program recorded thereon.

For example, when the present disclosure is achieved by a program (software), each step is performed by the program that is executed using hardware resources such as a CPU, memory, and an input/output circuit of a computer. In other words, each of the steps is executed due to the CPU obtaining data from the memory, input/output circuit, or the like, calculating the data and outputting a calculation result to the memory, the input/output circuit, or the like.

Note that each of the structural elements included in information processing system 10 in the above embodiment may be achieved by dedicated hardware, or may be achieved by executing a software program suitable to each of the structural elements. Each structural element may be achieved by a program executer such as a CPU or a processor reading a program from a recording medium such as a hard disk or semiconductor memory and executing the program.

Part or all of the functions of information processing system 10 according to the above embodiment may be achieved as a large scale integrated (LSI) circuit, which is an integrated circuit. These may take the form of individual chips, or may be partially or entirely packaged into a single chip. Furthermore, ways to achieve circuit integration are not limited to the large scale integration (LSI), and a dedicated circuit or a general purpose processor can also achieve the integration. It may also be possible to utilize a field programmable gate array (FPGA) that can be programmed after the LSI production or a reconfigurable processor that can reconfigure the connection and settings of a circuit cell inside the LSI circuit.

Furthermore, the present disclosure also includes many variations of the embodiment described above within the range conceivable by a person skilled in the art without departing from the teachings of the present disclosure.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is applicable to systems in which HMDs are used.

1. An information processing method that is executed by a computer, the information processing method comprising:
obtaining a video obtained by capturing a head-mounted display (HMD) user wearing a head-mounted display or information about visual content presented on the head-mounted display;
determining whether the HMD user will take an action that affects a nearby user who is present within a predetermined range corresponding to the HMD user, based on the video or the information about the visual content; and
presenting alert information to at least one of the HMD user or the nearby user when the HMD user is determined to take an action that affects the nearby user.

2. The information processing method according to claim 1, wherein
in the determining, a situation of the HMD user in the visual content is analyzed using the information about the visual content, and whether the HMD user will take an action that affects the nearby user is determined based on the situation analyzed.

3. The information processing method according to claim 1, wherein
in the determining, a movement of the HMD user is analyzed based on the video, and whether the HMD user will take an action that affects the nearby user is determined based on the movement determined.

4. The information processing method according to claim 1, further comprising:
determining whether the nearby user is likely to approach the HMD user, wherein
in the presenting, when the HMD user is determined to take an action that affects the nearby user and the nearby user is determined to be likely to approach the HMD user, the alert information is presented to at least one of the HMD user or the nearby user.

5. The information processing method according to claim 1, wherein
the predetermined range is a range of a predetermined distance from the HMD user.

6. The information processing method according to claim 1, wherein
the predetermined range is an area in which the HMD user is present.

7. The information processing method according to claim 1, wherein
in the presenting, the alert information is presented using tactile feedback.

8. A non-transitory computer-readable recording medium having recorded thereon a program for causing a computer to execute the information processing method according to claim 1.

9. An information processing system comprising:
an obtainer that obtains a video obtained by capturing a head-mounted display (HMD) user wearing a head-mounted display or information about visual content presented on the head-mounted display;
an HMD user situation determiner that determines whether the HMD user will take an action that affects a nearby user who is present within a predetermined range corresponding to the HMD user, based on the video or the information about the visual content; and
a presenter that presents alert information to at least one of the HMD user or the nearby user when the HMD user is determined to take an action that affects the nearby user.
